(19) United States
(12) Patent Application Publication
(10) Pub. No.: US 2010/0235780 A1
(43) Pub. Date: Sep. 16, 2010

(54) System and Method for Identifying Words Based on a Sequence of Keyboard Events

(76) Inventors: Wayne C. Westerman, San Francisco, CA (US); Kenneth L. Kocienda, Sunnyvale, CA (US); Drew M. Wilson, Mountain View, CA (US); Deborah E. Goldsmith, Los Gatos, CA (US); Leland D. Collins, Palo Alto, CA (US)

Correspondence Address: Morgan Lewis & Bockius LLP/ AI, 2 Palo Alto Square, 3000 El Camino Real, Suite 700, Palo Alto, CA, 94306, US

(21) Appl. No.: 12/505,382

(22) Filed: Jul. 17, 2009

Related U.S. Application Data
(60) Provisional application No. 61/160,704, filed on Mar. 16, 2009.

(51) Int. Cl. G06F 17/30

(52) U.S. Cl. 715/797; 707/E17.07

(57) ABSTRACT

A system, a computer readable storage medium including instructions, and computer-implemented method for displaying at least one word based on a sequence of keyboard events. A sequence of keyboard events representing keystrokes is received. The sequence of keyboard events is processed by: accessing and traversing nodes of a trie data structure in accordance with the sequence of keyboard events and upon arriving at a word node of the trie data structure, identifying one or more corresponding words to be displayed, and displaying at least one word of the one or more corresponding words to be displayed.

### RELATED APPLICATIONS

This application claims priority under 35 U.S.C. §119 to U.S. Provisional Patent Application No. 61/160,704, filed on Mar. 16, 2009, which application is incorporated by reference herein in its entirety.

### TECHNICAL FIELD

The disclosed embodiments relate generally to processing keyboard events. More particularly, the disclosed embodiments relate to systems and methods for identifying words based on a sequence of keyboard events.

### BACKGROUND

A computing device typically includes a user interface that may be used to interact with the computing device. The user interface may include a display and/or input devices such as a keyboard and/or a mouse. The user may use the keyboard to generate a sequence of keyboard events (e.g., typing words). However, a user may incorrectly type a word. For example, the user may intend to type the word “thirst” but instead types the word “thiest.” The user then either manually corrects the error or relies on an application executing on the computing device to automatically correct the error or suggest one or more replacement words (sometimes called spelling corrections). In cases where the application on the computer device automatically corrects spelling errors or suggests one or more spelling corrections, the application typically includes one or more dictionaries or language data that are used to determine whether a received keystroke sequence corresponds to a known word, and also to determine an appropriate correction or a set of candidate replacement words when the received keystroke sequence does not correspond to a known word. Unfortunately, these dictionaries are often large. On mobile devices, these dictionaries may consume a substantial amount of memory of the mobile device. Thus, it would be desirable to provide systems and methods for identifying words based on a sequence of keyboard events without the above-described drawbacks.

### SUMMARY

To address the aforementioned drawbacks, some embodiments provide a system, a computer readable storage medium including instructions, and a computer-implemented method for identifying at least one word based on a sequence of keyboard events. The keyboard events may be received from a physical keyboard, or a soft keyboard implemented using a touch screen display having a touch-sensitive surface. In these embodiments, a trie data structure is used to represent words in a respective language, as described herein. Each node of the trie data structure may represent a character in a sequence of valid characters in a respective language. The size of the trie data structure may be reduced by combining trie nodes that represent different character forms of a character. For example, a trie node may represent all forms of the character “e” (e.g., accented, unaccented, capitalized, uncapitalized, etc.).

Some embodiments provide a system, a computer readable storage medium including instructions, and computer-implemented method for displaying at least one word based on a sequence of keyboard events. A sequence of keyboard events representing keystrokes is received. The sequence of keyboard events is processed by: accessing and traversing a sequence of nodes of a trie data structure in accordance with the sequence of keyboard events, and upon arriving at a word node of the trie data structure, identifying one or more corresponding words to be displayed and displaying at least one word corresponding to the one or more corresponding words to be displayed. In some embodiments, the trie data structure includes intermediate nodes and word nodes. Each word node of the trie data structure corresponds to one or more complete words and has a default sequence of symbols corresponding to the traversed sequence of nodes ending at the word node (which also corresponds to a respective sequence of keyboard events). The trie data structure may also include a first respective word node that includes a reference to a word record specifying two or more distinct words based at least in part on the corresponding sequence of keyboard events and a second respective word node that does not have a reference to a word record. A complete word corresponding to the second respective word node is determined based on a traversed sequence of nodes (ending at the second respective word node) in the trie data structure.

In some embodiments, nodes of the trie data structure are accessed and traversed in accordance with the sequence of keyboard events as follows. A first keyboard event representing a first keystroke in the sequence of keyboard events is received. A first character corresponding to the first keyboard event is then determined. A first node of the trie data structure that corresponds to the first character is located.

In some embodiments, when the first node of the trie data structure corresponds only to the first character, for a respective subsequent keyboard event in the sequence of keyboard events, a next character corresponding to the subsequent keyboard event is determined. A next node of the trie data structure is then traversed from a current node of the trie data structure, wherein the next node of the trie data structure corresponds to the next character.

In some embodiments, when the first node of the trie data structure corresponds to a sequence of characters including the first character and a second character that follows the first character, for a respective subsequent keyboard event in the sequence of keyboard events, a next character corresponding to the subsequent keyboard event is determined. When the next character is the second character, no nodes are traversed (e.g., the process for handling keyboard events remains at the first node of the trie data structure).

In some embodiments, one or more corresponding words to be displayed are identified as follows. It is determined whether the node of the trie data structure has a corresponding word list. In response to determining that the node of the trie data structure has a corresponding word list, one or more words from the word list to be displayed are identified.

In some embodiments, the corresponding word list includes metadata for the one or more words.

In some embodiments, the metadata includes a frequency of occurrence of a respective word in a respective language.

In some embodiments, in response to determining that the node of the trie data structure does not have a corresponding word list, a single word to be displayed is derived, based on the traversed sequence of nodes in the trie data structure.

In some embodiments, one or more words to be displayed are derived based on one or more nodes of the trie data structure downstream from a last node of the traversed sequence of nodes.

In some embodiments, the corresponding word list includes one or more entries, and when the corresponding word list includes two or more entries, each entry corresponds to a respective word and includes a frequency value indicating frequency of occurrence of the respective word.

In some embodiments, one or more corresponding words to be displayed are identified as follows. It is determined whether the node of the trie data structure has a corresponding word list. In response to determining that the node of the trie data structure has a corresponding word list, one or more transformation operations on the default sequence of symbols to produce a word to be displayed is performed.

In some embodiments, a respective entry of the corresponding word list includes a substitution list, the substitution list including one or more transformation operations, including a transformation operation selected from the group consisting of: a transformation operation to substitute specified characters of the default sequence of symbols, a transformation operation to insert one or more characters at a specified position in the default sequence of symbols, a transformation operation to insert one or more symbols at a specified position in the default sequence of symbols, and a transformation operation to transform one or more characters of the default sequence of symbols.

In some embodiments, a respective node of the trie data structure corresponds to one or more character forms.

In some embodiments, the one or more character forms include at least one of: a capitalized character form, an uncapitalized character form, an accented character form, and an unaccented character form.

In some embodiments, only a single word is displayed based on a frequency of occurrence of the one word in a respective language.

### BRIEF DESCRIPTION OF THE DRAWINGS

FIG. 1 is a block diagram illustrating a device, according to some embodiments.

FIG. 2A is a block diagram illustrating an exemplary keyboard event in a sequence of keyboard events in a user interface of a device, according to some embodiments.

FIG. 2B is a block diagram illustrating another exemplary keyboard event in the sequence of keyboard events in the user interface of the device, according to some embodiments.

FIG. 2C is a block diagram illustrating another exemplary keyboard event in the sequence of keyboard events in the user interface of the device, according to some embodiments.

FIG. 2D is a block diagram illustrating another exemplary keyboard event in the sequence of keyboard events in the user interface of the device, according to some embodiments.

FIG. 2E is a block diagram illustrating another exemplary keyboard event in the sequence of keyboard events in the user interface of the device, according to some embodiments.

FIG. 3 is a block diagram illustrating a device, according to some embodiments.

FIG. 4 illustrates an exemplary trie data structure, according to some embodiments.

FIG. 5 illustrates an exemplary word list, according to some embodiments.

FIG. 6 illustrates an exemplary trie data structure, according to some embodiments.

FIG. 7 illustrates an exemplary trie data structure, according to some embodiments.

FIG. 8 is a flow diagram of a method for processing a sequence of keyboard events, according to some embodiments.

FIG. 9 is a flow diagram of a method for traversing a trie data structure in accordance with a sequence of keyboard events, according to some embodiments.

FIG. 10 is a flow diagram of a method for traversing a trie data structure in accordance with a sequence of keyboard events, according to some embodiments.

FIG. 11 is a flow diagram of a method for traversing a trie data structure in accordance with a sequence of keyboard events, according to some embodiments.

FIG. 12 is a flow diagram of a method for identifying words to be displayed in the user interface of a device, according to some embodiments.

Like reference numerals refer to corresponding parts throughout the drawings.

### DESCRIPTION OF EMBODIMENTS

As discussed above, a dictionary of valid words for a respective language may consume a substantial amount of memory of a mobile device. Existing dictionaries typically include word records for each and every valid word in the dictionary, in addition to a trie data structure representing all character sequences that correspond to words in the dictionary. Furthermore, the trie data structure generally includes separate nodes for all possible forms of the valid words (e.g., capitalized forms of words, accented forms of words, etc.) in the dictionary. While the trie data structure and word records of existing dictionaries are efficient for dictionary lookup operations, the present invention is based on techniques for reducing the amount of storage used while retaining the lookup efficiency of the existing data structures.

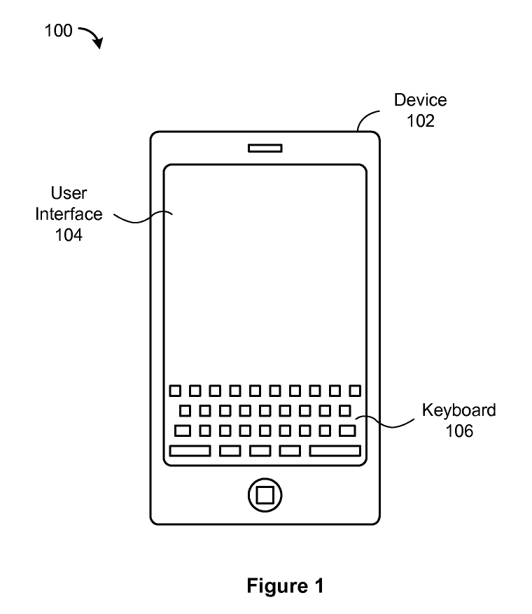

FIG. 1 is a block diagram 100 illustrating a device 102, according to some embodiments. The device 102 may be any device including, but not limited to, a desktop computer system, a laptop computer system, mobile phone, a smart phone, a personal digital assistant, and a portable or handheld navigation device. The device 102 may include a user interface 104.

In some embodiments, the device 102 includes a touch screen display. In these embodiments, the user interface 104 includes an on-screen keyboard 106 that is used by a user to interact with the device 102. Alternatively, the keyboard 106 may be separate and distinct from the device 102. For example, the keyboard 106 may be a wired or wireless keyboard that is coupled to the device 102.

In some embodiments, the device 102 includes a display and one or more input devices (e.g., a keyboard, a mouse, etc.) that are coupled to the device 102. In these embodiments, the one or more input devices are separate and distinct from the device 102. For example, the one or more input devices may include a keyboard, a mouse, a trackpad, a trackball, and an electronic pen.

When typing on the keyboard 106, the user generates a sequence of keyboard events that are processed by one or more processors of the device 102. In some embodiments, the one or more processors of the device 102 process the sequence of keyboard events to identify one or more words to be displayed. In some embodiments, the one or more processors of the device 102 process the sequence of keyboard events to identify the one or more words to be displayed in real-time as the keyboard events are received. In some embodiments, the one or more processors of the device 102 wait until a specified condition has occurred prior to processing the keyboard events to identify the one or more words to be displayed. For example, the specified condition may include the occurrence of a specified character being typed (e.g., a space or a punctuation, etc.) in the sequence of keyboard events. Similarly, the specified condition may include an occurrence of a specified time interval between keyboard events (e.g., 1 second, etc.).

Note that this specification uses the term “word” to refer to a sequence of characters. Furthermore, this specification uses the term “character” to refer to letters, pictographs, symbols, scripts, and/or punctuation marks.

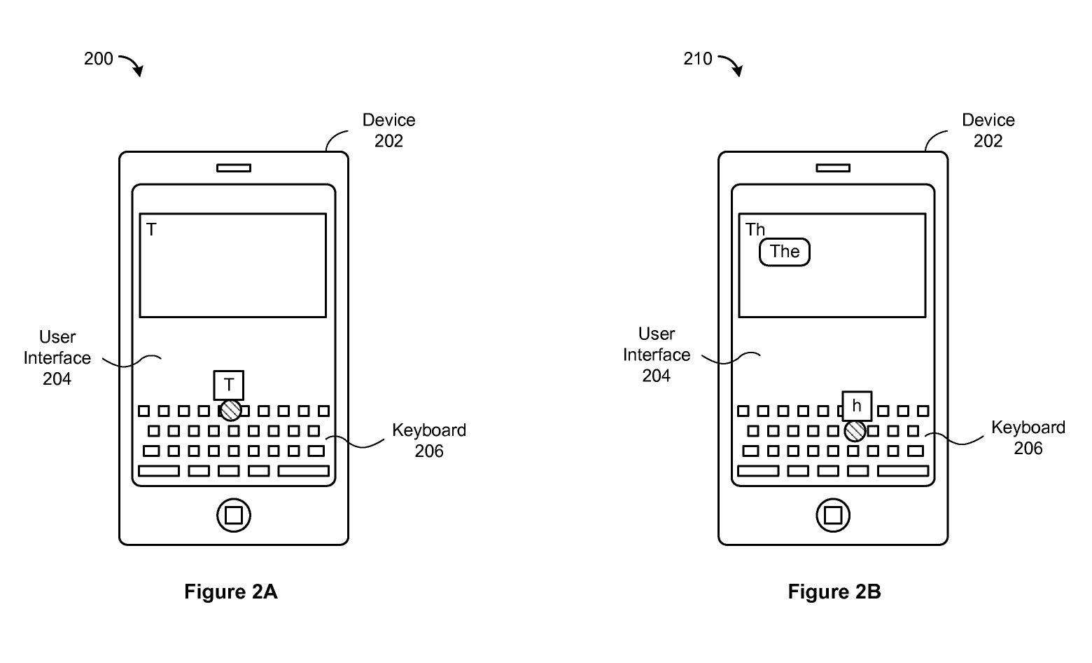

FIGS. 2A-2E illustrate a sequence of keyboard events received from a user of a device 202. The device 202 may be the device 102 in FIG. 1. The device 202 includes a user interface 204 and an on-screen keyboard 206. Although FIGS. 2A-2E illustrate a touch screen display including the on-screen keyboard 206, the process described with reference to these figures may apply to any type of user interface. As illustrated in FIGS. 2A-2E, the sequence of keyboard events are being processed in real-time by one or more processors of the device 202. However, the sequence of keyboard events may be processed when specified keyboard events occur, as described above.

FIG. 2A is a block diagram 200 illustrating an exemplary keyboard event in a sequence of keyboard events in the user interface 204 of the device 202, according to some embodiments. As illustrated in FIG. 2A, the user typed the letter “T” using the on-screen keyboard 206.

FIG. 2B is a block diagram 210 illustrating another exemplary keyboard event in the sequence of keyboard events in the user interface 204 of the device 202, according to some embodiments. As illustrated in FIG. 2B, the user typed the letter “h” using the on-screen keyboard 206. At this point, the one or more processors of the device 202 may search a dictionary to identify one or more words based on the sequence of keyboard events (e.g., “Th”). For example, the one or more processors of the device 202 may determine that the sequence of keyboard events corresponds to the word “The.” Note that the term “dictionary” is used refer to “language data” that may include valid characters, words, and/or phrases for a respective language.

FIG. 2C is a block diagram 220 illustrating another exemplary keyboard event in the sequence of keyboard events in the user interface 204 of the device 202, according to some embodiments. As illustrated in FIG. 2C, the user typed the letter “i” using the on-screen keyboard 206. At this point, the one or more processors of the device 202 may search a dictionary to identify one or more words based on the sequence of keyboard events (e.g., “Thi”). For example, the one or more processors of the device 202 may determine that the sequence of keyboard events corresponds to the word “This.”

FIG. 2D is a block diagram 230 illustrating another exemplary keyboard event in the sequence of keyboard events in the user interface 204 of the device 202, according to some embodiments. As illustrated in FIG. 2D, the user typed the letter “r” using the on-screen keyboard 206. At this point, the one or more processors of the device 202 may search a dictionary to identify one or more words based on the sequence of keyboard events (e.g., “Thir”). For example, the one or more processors of the device 202 may determine that the sequence of keyboard events corresponds to the word “Thirst.”

FIG. 2E is a block diagram 240 illustrating another exemplary keyboard event in the sequence of keyboard events in the user interface 204 of the device 202, according to some embodiments. As illustrated in FIG. 2D, the user typed the letter “r” using the on-screen keyboard 206. At this point, the one or more processors of the device 202 may search a dictionary to identify one or more words based on the sequence of keyboard events (e.g., “Thir”). For example, the one or more processors of the device 202 may determine that the sequence of keyboard events corresponds to the word “Thirst.”

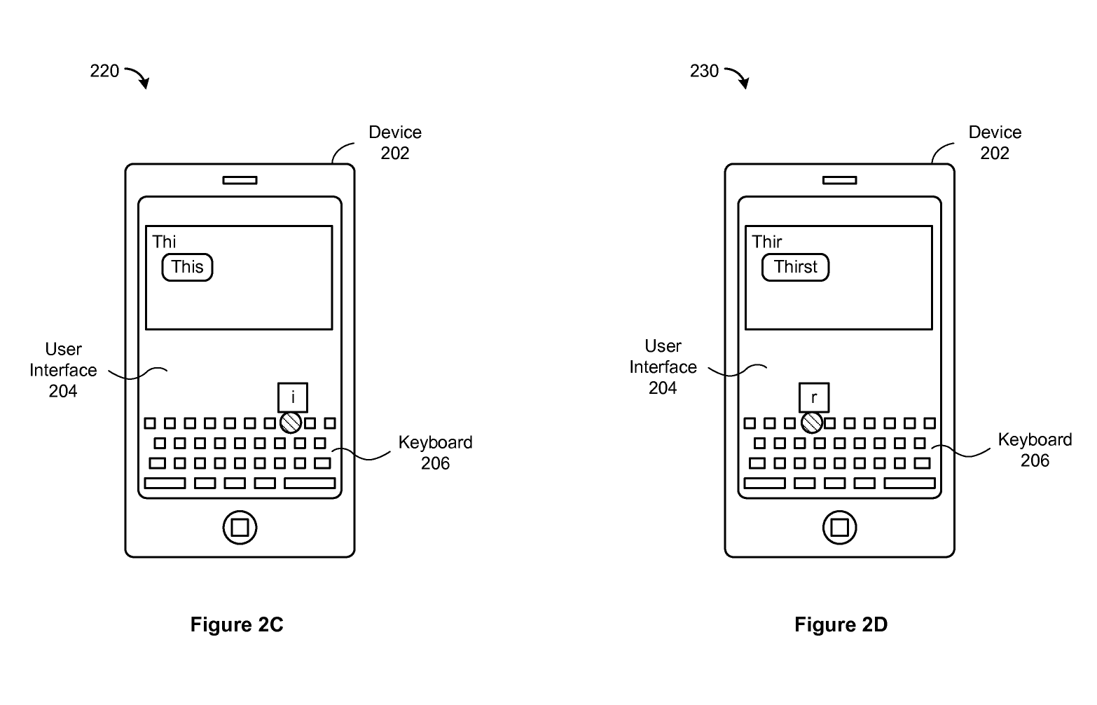

FIG. 3 is a block diagram illustrating a device 300, according to some embodiments. The device 300 may be the device 102 in FIG. 1 and the device 202 in FIG. 2. The device 300 typically includes one or more processing units (CPU's) 302, one or more network or other communications interfaces 304, memory 310, and one or more communication buses 309 for interconnecting these components. The communication buses 309 may include circuitry (sometimes called a chipset) that interconnects and controls communications between system components. The device 300 optionally may include a user interface 305 comprising a display device 306 (e.g., a touch screen display, etc.) and input devices 308 (e.g., keyboard, mouse, touch screen, keypads, etc.). In some embodiments, the input devices are on-screen input devices. Memory 310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 310 may optionally include one or more storage devices remotely located from the CPU(s) 302. Memory 310, or alternately the non-volatile memory device(s) within memory 310, comprises a computer readable storage medium. In some embodiments, memory 310 stores the following programs, modules and data structures, or a subset thereof:
an operating system 312 that includes procedures for handling various basic system services and for performing hardware dependent tasks;
a communication module 314 that is used for connecting the device 300 to other devices via the one or more communication interfaces 304 (wired or wireless) and one or more communication networks, such as the Internet, other wide area networks, local area networks, metropolitan area networks, and so on;
a user interface module 316 that receives commands from the user via the input devices 308 and generates user interface objects in the display device 306;
one or more applications 318 (e.g., an email application, a web browser application, a text messaging application, etc.);
a dictionary module 320 that receives a sequence of keyboard events and identifies one or more words based on the sequence of keyboard events, a keyboard model 332 and/or language data 322, as described herein;
the language data 322 for one or more languages, including trie data structures 324 that represent valid characters, words, and/or phrases for the one or more languages, word records 326 that include two or more words associated with a sequence of keyboard events, and sort keys 328 that represent characters of a respective language; and
a keyboard module 330 that receives a keyboard event from the user interface 305 and determines a character corresponding to the keyboard event based on the keyboard model 332 for a respective language.

A trie data structure, also called a prefix tree, is an ordered tree data structure that is used to store information. The keys to the nodes are strings, and the position of each node in the tree corresponds to its key. All descendants of a node in a trie data structure have a common prefix of the string associated with that node. The root of the trie data structure is typically associated with an empty string.

Each of the above identified elements may be stored in one or more of the previously mentioned memory devices, and corresponds to a set of instructions for performing a function described above. The set of instructions can be executed by one or more processors (e.g., the CPUs 302). The above identified modules or programs (i.e., sets of instructions) need not be implemented as separate software programs, procedures or modules, and thus various subsets of these modules may be combined or otherwise re-arranged in various embodiments. In some embodiments, memory 310 may store a subset of the modules and data structures identified above. Furthermore, memory 310 may store additional modules and data structures not described above.

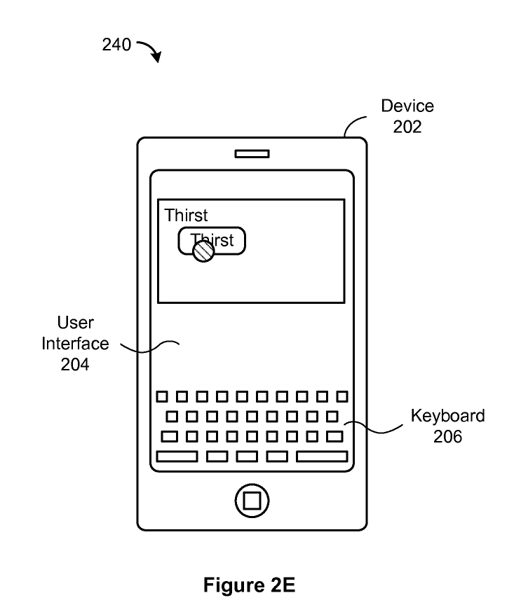

FIG. 4 is a block diagram 400 illustrating an exemplary trie data structure 402, according to some embodiments. In some embodiments, the trie data structure 402 is stored in memory of a device (e.g., memory 310 in FIG. 3). The trie data structure 402 includes a plurality of trie nodes 404 located at memory locations 403 in memory for a device (e.g., the device 102 in FIG. 1, the device 202 in FIG. 2, the device 300 in FIG. 3, etc.). A respective trie node 404-4 includes a flags field 406 and a sort keys field 408 (e.g., sort keys 328 in FIG. 3). A sort key is a character that represents all forms (e.g., accented, unaccented, capitalized, uncapitalized, etc.) of the character. For example, the sort key “e” may represent the following characters forms “e”, “E”, “è”, “é”, “ê”, “ë”, and “ [symbol] ”. Thus, instead of using multiple nodes of the trie data structure to represent the different character forms of “e”, all of the character forms of “e” are represented by a single node of the trie data structure. Furthermore, in some embodiments, each sort key has a default character form, for example a character form without accents or the like.

The flags field 406 may include a child field 406-1 that indicates that the trie node 404-3 is associated with one or more child nodes of the trie data structure 402, a frequency field 406-2 that indicates that the trie node 404-3 is associated with a frequency value field as described below, a word-termination probability field 406-3 that indicates that the trie node 404-3 is associated a probability 416 that a sequence of trie nodes traversed in the trie data structure 402 that ends at the trie node 404-3 represents one or more complete words, a word list field 406-4 that indicates that the trie node 404-3 is associated with a word list as described below, a child offset type field 406-5 that indicates the length of an address (e.g., 8 bits, 16 bits, 24 bits, etc.) that points to a child trie node of the trie node 404-3, a sort key field 406-6 that indicates that the number of sort keys field 408 associated with the trie node 404-3. In some embodiments, the flags field 406 is a bit-packed field. For example, the flags field 406 may be 8 bits, where the child field 406-1, the frequency field 406-2, the word-termination probability field 406-3 and the word list field 406-1 may be one-bit fields, and the child offset type field 406-5 and the sort key field 406-6 are two-bit fields.

In some embodiments, a respective trie node 404 may be associated with two or more sort keys when the respective trie node 404 only includes a single child node. Thus, the sort keys field 408 may include a plurality of sort keys associated with the trie node 404-3. For example, the trie node 404-3 may be associated with the sort keys “s” and “t.” Accordingly, the sort keys “s” and “t” are stored in the sort keys field 408 for the trie node 404-3.

The respective trie node 404-3 may optionally include a child offset field 410, a probability field 412, a word address field 414, a word-termination probability 416, and any combination of these fields. The child offset field 410 includes an address of a child node of the trie node 403-3. In some embodiments, the address is an address offset relative to the address of a location in memory of the trie node 403-3. In some embodiments, the address is an absolute address. In some embodiments, the child offset field 418 is a variable length field whose length is denoted by the child offset type field 406-5. For example, the child offset type field 406-5 may indicate that an address in the child offset field is 16 bits long. The probability field 412 indicates the relative probability, relative to siblings of a current trie node (e.g., children of an immediate ancestor node of the current trie node), that characters associated with the current trie node follow characters associated with the immediate ancestor trie node. For example, if the immediate ancestor trie node has five children trie nodes, the relative probabilities that characters associated with each of the five children trie nodes would follow characters associated with the immediate ancestor trie node would be indicated by the probability fields 412 in those five children nodes. Note that the frequency that a given word in the trie data structure occurs in a training corpus (e.g., a dictionary, documents, etc., that includes a set of valid words for a respective language) is calculated by multiplying the total number of words in the corpus by the probability of each of the trie nodes traversed to form the word.

A trie node that is associated with one or more words is referred to as a “word node.” Both internal trie nodes and leaf trie nodes may be word nodes. In some embodiments, if the trie node 404-3 is associated with one or more complete words, the word-termination probability flag 406-3 of the node will be set and the node will include a word-termination probability 416 having non-zero value, indicating the likelihood that the keystroke that caused the process to reach this node is the last keystroke of the word being entered by the user. In some embodiments, the word-termination probability 416 is set only for internal tries nodes that correspond to at least one complete word. In these embodiments, leaf trie nodes (e.g., trie nodes that do not have any children trie nodes) always correspond to at least one complete word, and therefore the word-termination probability is inherently set to 1.0. Accordingly, leaf trie nodes do not include an explicit word-termination probability field.

Furthermore, when a word node is associated with more than one word, or when any word associated with the node differs from a word derived from a sequence of traversed nodes (i.e., a “default form” of the word) ending at the word node, then the word node includes a word address field 414. The word address field 414 specifies the address of a location in memory of a first word in a word list (e.g., word list 420). In some embodiments, the address is an address offset relative to the address of a location in memory of the trie node 403-3, while in other embodiments the address in the word address field 414 is an absolute address.

In some embodiments, word nodes that correspond to only a single word, which is the “default” word form for the sequence of trie nodes ending at the word node, do not include a pointer or offset (see word address field 414) to a word list. This applies to both internal trie nodes and leaf trie nodes that are word nodes. In these embodiments, the default word form for a word node is the sequence of default character forms for the sequence of trie nodes traversed to arrive at the word node. These embodiments reduce the size of a dictionary by at least the amount of space saved by not using word lists to represent single words that are the default form (and only word) corresponding to the sequence of traversed trie nodes for the word node.

In other embodiments, even greater compression can be achieved by making the default character forms for a sequence of trie nodes to be context dependent, thereby reducing the number of word nodes that require a word list. For example, if a particular letter always or almost always has a first variation (e.g., a particular accent) when preceded (and/or followed) by a particular pattern of characters, the first variation of that letter would be the default character form in that context. More generally, a set of rules may be provided to define the default character forms for various letters or characters in accordance with the context of the letter or character. An example of such a rule is: in the French language, the default form for the character “c” is “c” except when the character “c” is preceded by at least two characters and followed by an “a,” in which case the default form for the character “c” is “ç” (c with cedilla). In accordance with this example of a rule, if a user, while entering text in the French language, enters a plurality of characters followed by the characters “c” and a”, the default form of the word is “ . . . ça . . . ” (with diacritic marks), where the ellipses represent characters preceding and following the characters “c” and “a”. On the other hand, if the user enters the characters “c” and “e”, the default form of the word is “ . . . ce . . . ” (without diacritic marks) because the cedilla (“ç”) in French never precedes the vowels “e” or “i”.

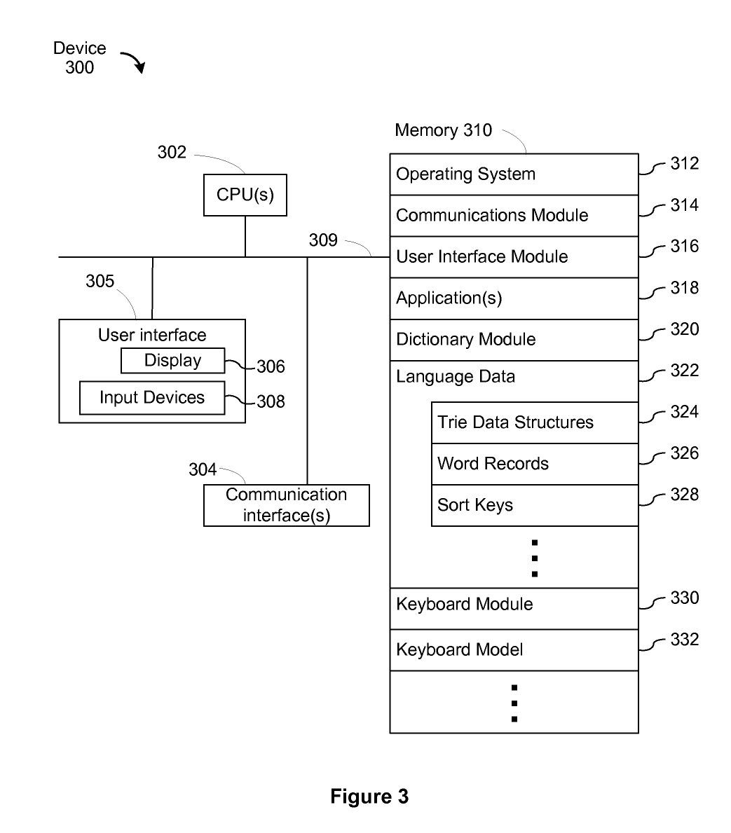

In some embodiments, when a word cannot be derived solely from the sequence of traversed trie nodes (e.g., based on a sequence of keyboard events) or when a word's final form requires modification, the trie node is associated with a word list that includes one or more words. FIG. 5 is a block diagram 500 illustrating exemplary word records 502, according to some embodiments. In some embodiments, the word records 502 are stored in memory of a device (e.g., memory 310 in FIG. 3). The word records 502 include a plurality of word lists 504 located at addresses 503 in memory of the device. A respective word list 504-2 includes one or more word entries 506.

A respective word entry 506-1 may includes a last word flag 508-1, a frequency flag 508-2, and a word 508-3. Since the words in the word list 504-2 may be stored in sequential locations in memory of the device, the last word flag 508-1 indicates whether the word entry 506-1 is the last word entry in the word list 504-2. The frequency 508-2 indicates the frequency that the word 508-3 of the word entry 506-1 appears in a respective language. Note that the frequency field 508-3 is typically used to select a single word (or to generate a ranked list of words) when there are two or more word entries in a respective word list.

In some embodiments, a respective word entry 506-3 includes a transformation list 510-1. The transformation list 510-1 may include one or more transformation operations 520 that indicate specified transformations to be performed on a word derived from a traversed sequence of trie nodes (e.g., traversed based on a sequence of keyboard events) in the trie data structure 402 to produce a word. A respective transformation 520-3 includes a last transformation flag 522-1 that indicates whether the transformation 520-3 is the last transformation in the transformation list 510-1 associated with a respective trie node of the trie data structure 402, a position field 522-2 that indicates a position in the derived word on which to perform the transformation, a transformation type 522-3 that indicates a type of transformation to be performed (e.g., inserting characters, deleting characters, substitution characters, combining characters, etc.), and an optional transformation character 522-4 that is the character(s) that is used by the transformation operation 520-3.

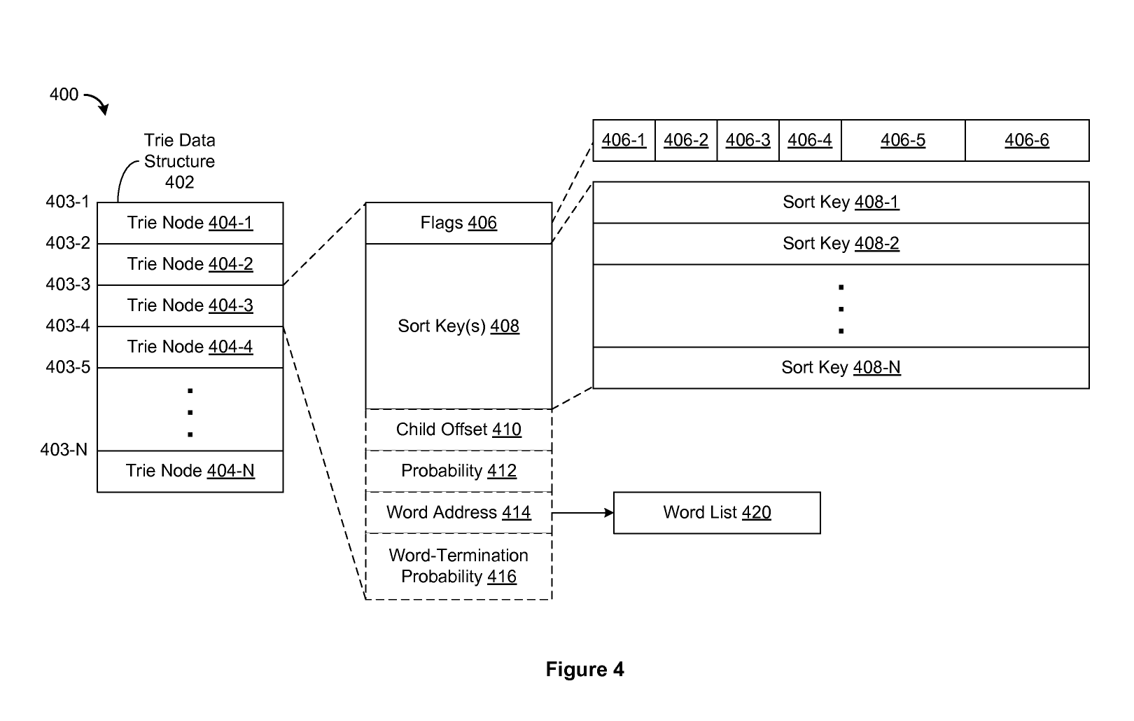

FIG. 6 illustrates a subset of an exemplary trie data structure 600, according to some embodiments. The trie data structure 600 includes a number of sort keys representing characters of a language. In FIG. 6, the language is English and the characters are letters of the English alphabet. Referring to the example provided in FIG. 2 above, as a user types the sequence of characters “t” “h” “i” “r” using a user interface of a device, one or more processors of a device access and traverse trie nodes of the trie data structure 600. Specifically, the one or more processors of the device traverse trie nodes 602, 604, 606, and 608. At each node, the one or more processors of the device may determine whether the sequence of traversed trie nodes is associated with one or more words. If the sequence of traversed nodes is associated with one or more words, the one or more processors may display the one or more words in the user interface of the device. In this example, the one or more processors may determine that the sequence of traversed trie nodes 602, 604, 606, and 608 (e.g., representing the characters “t” “h” “i” “r”) are not associated with one or more words in English and do not display any words. In some embodiments, the one or processors predict a word based on the sequence of traversed trie nodes and trie nodes that are reachable from the last trie node traversed. In this example, the one or more processors may determine that the sequence of traversed trie nodes 602, 604, 606, and 608 may correspond to the word “thirst” or “thirty,” both of which are associated with trie nodes that are reachable from trie node 608 (e.g., trie nodes 610 and 612, and trie nodes 614 and 616, respectively). Thus, the one or more processors may display one or more of the words “thirst” or “thirty” (or other words that may follow from trie node 608) in the user interface of the device.

In some embodiments, a keyboard model (e.g., the keyboard model 332 in FIG. 3) is used in conjunction with a trie data structure (e.g., the trie data structure 600) to determine one or more words to be displayed. In these embodiments, the keyboard model is used to determine a probability that the user selected a key on a keyboard. For example, a user may have typed the letter “d” but intended to type the letter “e.” Since the keyboard model includes information about the layout of the keyboard, the one or more processors of the device may determine that although the user typed the letter “d”, the user may have intended to type and of the letters “e”, “w”, “r”, “s”, “f”, “x”, “c”. In some embodiments, the one or more processors maintains a set of sequences of traversed trie nodes that enumerate the possible sequence of keys of the keyboard selected by the user for each keyboard event received from the user. For example, if the user typed the keys “t” and “d”, the one or more processors may determine that the set of possible sequence of keys selected by the user may correspond to the sequence of trie nodes representing the sequences of characters “te”, “re”, “ge”, “ye”, etc., all of which correspond to valid combinations of characters in the English language. However, although the keyboard model may indicate that the user may have typed the keys “td”, the character sequence “td” is not a valid sequence in the English language. Thus, in these embodiments, the one or more processors of the device may drop from consideration any possible sequence of keys selected by the user that does not correspond to a valid sequence of characters in a respective language.

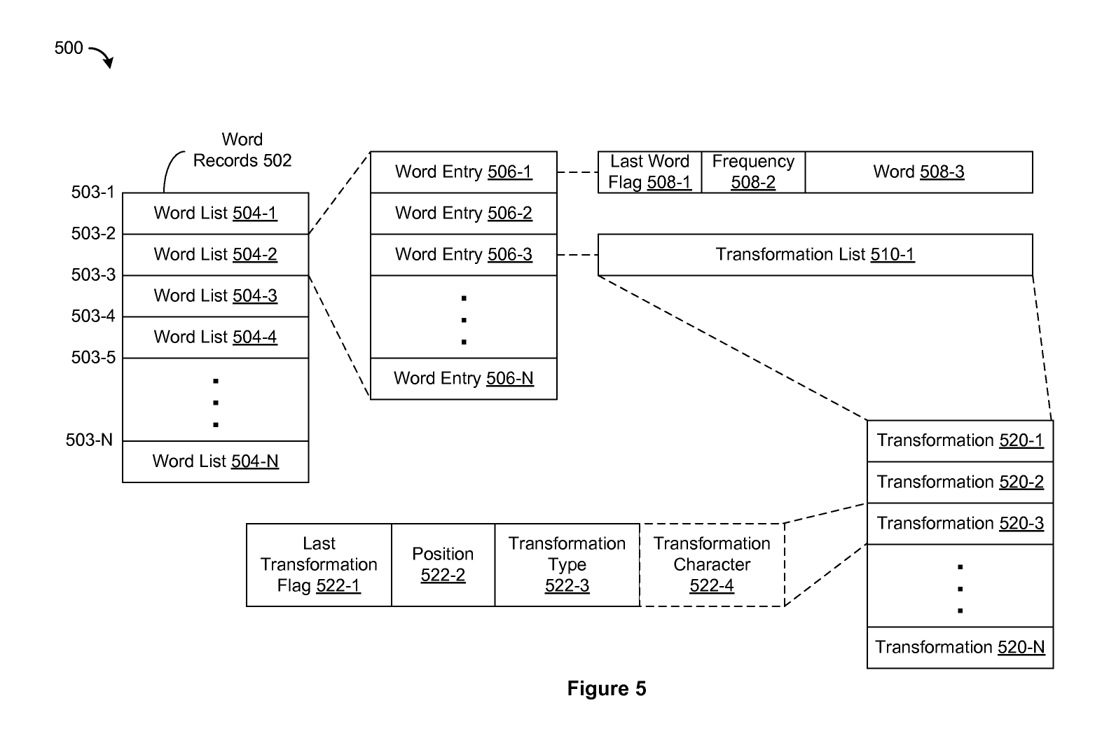

FIG. 7 illustrates a subset of an exemplary trie data structure 700. In some embodiments, the size of the trie data structure is reduced by merging nodes that represent common strings. As illustrated in FIG. 7, nodes 702, 704, 706, 708 representing the word “drop” and nodes 730, 732, 734, and 736 representing the word “stop” share the child trie nodes 710 (“ped”), 712 (“ping”) and 714 (“s”). Thus, the trie data structure 700 is reduced by at least 3 trie nodes. The process of combining suffixes and/or common strings at the end of a word is referred to as “tail compression.” The process of combining prefixes and/or common strings at the beginning of a word is referred to as “head compression.”

As described above, a sequence of traversed trie nodes include sort keys that represent characters of a word. However, a sort key does not include accented forms of the characters, punctuation, or capitalization. Thus, although a default form of a word may be represented by the sequence of traversed trie nodes, one or more transformations may need to be performed. For example, FIG. 7 illustrates a sequence of trie nodes 730, 738, 740, 742, and 744 that correspond to the sort keys “s”, “h”, “e”, “l”, and “l”, respectively. This sequence of trie nodes may correspond to the word “shell” or to the word “she'll”. To represent the word “she'll”, trie node 744 may be associated with a word list (e.g., the word list 504-2 in FIG. 5) that includes a transformation operation (e.g., the transformation operation 520-3 in FIG. 5) that inserts an apostrophe between the third and fourth characters of the word “shell”.

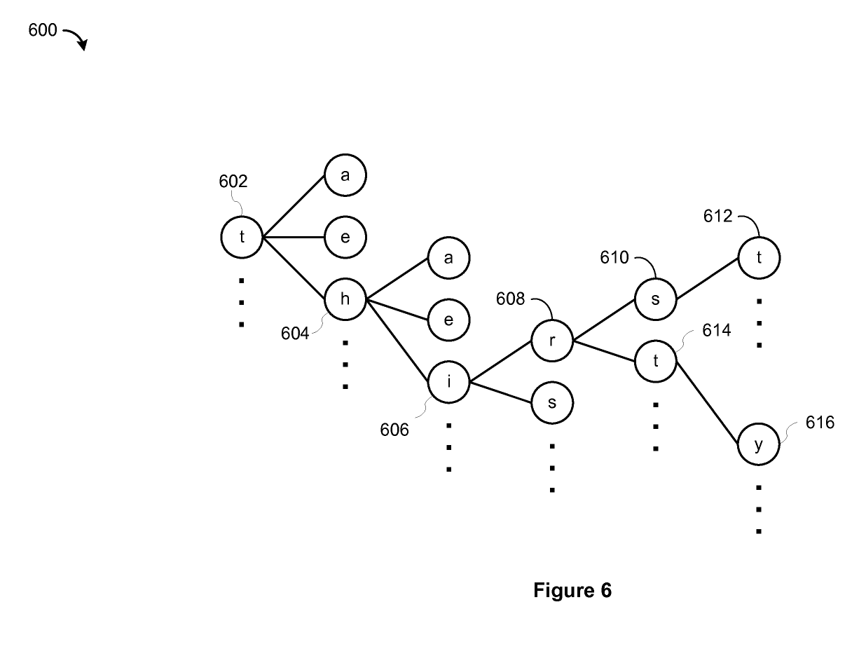

FIGS. 8-12 describe methods for processing a sequence of keyboard events to identify one or more words corresponding to the sequence of keyboard events. The methods described with respect to FIGS. 8-12 may be performed on a device having one or more processors executing one or more programs stored on memory of the device (e.g., the device 300 in FIG. 3).

FIG. 8 is a flowchart of a method 800 for processing a sequence of keyboard events, according to some embodiments. The one or more processors of the device receive (802) a sequence of keyboard events representing keystrokes. For example, the one or more processors of the device may receive the sequence of keyboard events from a keyboard of the device, as described above.

The one or more processors of the device then process (804) the sequence of keyboard events by: accessing and traversing (806) nodes of a trie data structure in accordance with the sequence of keyboard events, and upon arriving at a word node of the trie data structure, identifying (808) one or more corresponding words to be displayed and displaying (810) at least one word corresponding to the one or more corresponding words to be displayed in the user interface of the device. For example, the one or more corresponding words may include a word derived from the sequence of characters corresponding to the sequence of traversed trie nodes (e.g., see the discussion above with respect to word-termination probability field 416 in FIG. 4). Alternatively, the one or more corresponding words may include one or more words from a word list (e.g., see the discussion above with respect to the word address field 414 and the word list 420 in FIG. 4). In some embodiments, the one or more processors only identify one or more words corresponding to the sequence of keyboard events without displaying the one or more words in the user interface of the device.

In some embodiments, the trie data structure includes intermediate nodes (e.g., trie nodes in the sequence of traversed trie nodes that do not form complete words) and word nodes, each word node of the trie data structure corresponding to one or more complete words and having a default sequence of symbols (e.g., sort keys) corresponding to the sequence of traversed nodes ending at the word node (which also corresponds to a sequence of keyboard events). The trie data structure may also include a first respective word node including a reference to a word record specifying two or more distinct words based at least in part on the sequence of keyboard events and a second respective word node including no reference to a word record, wherein a complete word corresponding to the second respective word node is determined based on a traversed sequence of nodes in the trie data structure.

In some embodiments, only a single word is displayed based on a frequency of occurrence of the one word in a respective language.

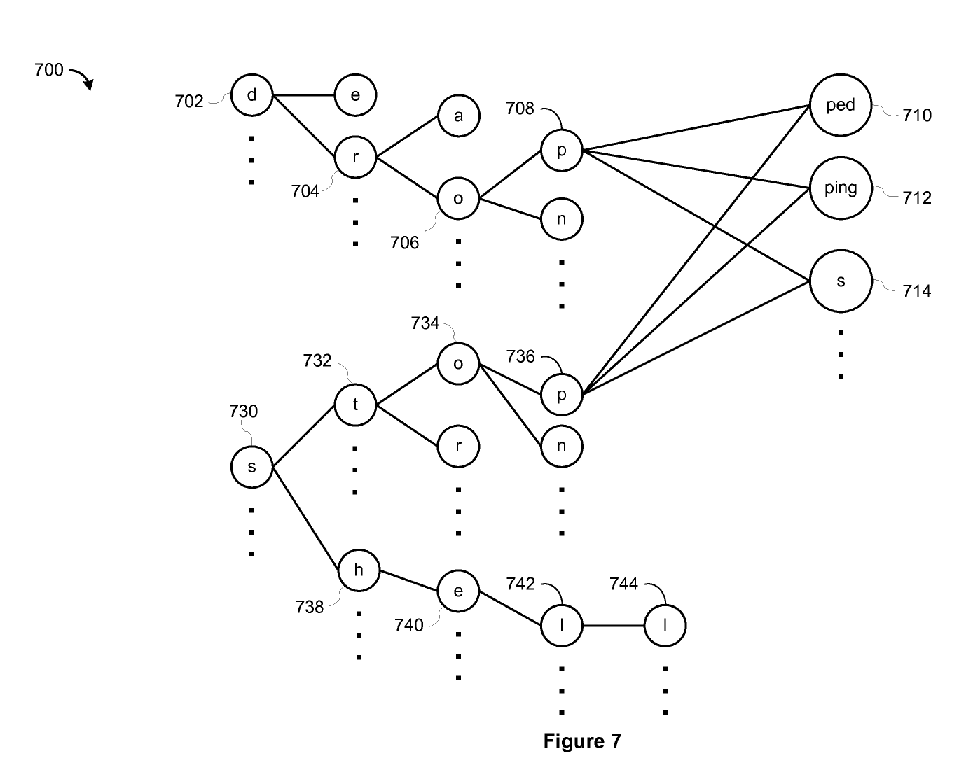

FIG. 9 is a flowchart of a method 900 for traversing a trie data structure in accordance with a sequence of keyboard events, according to some embodiments. The one or more processors of the device receive (902) a first keyboard event representing a first keystroke in the sequence of keyboard events. The one or more processors of the device determine (904) a first character corresponding to the first keyboard event. The one or more processors of the device locate (906) a first node of the trie data structure that corresponds to the first character.

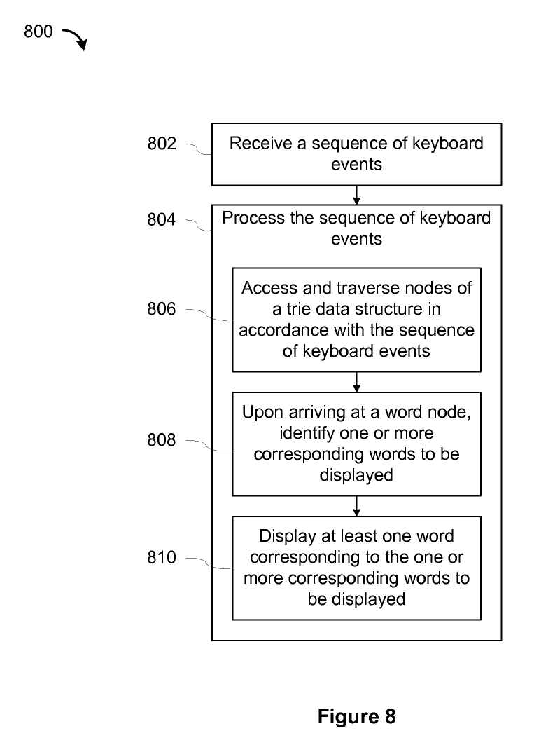

FIG. 10 is a flowchart of a method 1000 for traversing a trie data structure in accordance with a sequence of keyboard events, according to some embodiments. When the first node of the trie data structure corresponds only to the first character (e.g., the trie node only represents a single sort key), for a respective subsequent keyboard event in the sequence of keyboard events, the one or more processors of the device determine (1002) a next character corresponding to the subsequent keyboard event and traverse (1004) to a next node of the trie data structure from a current node of the trie data structure, wherein the next node of the trie data structure corresponds to the next character.

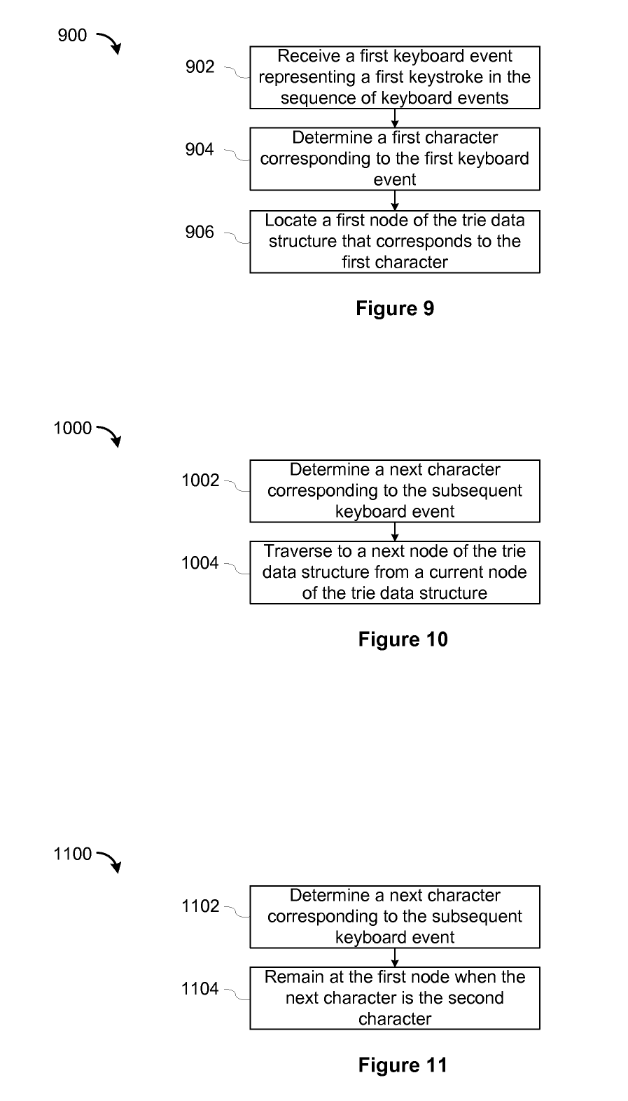

FIG. 11 is a flowchart of a method 1100 for traversing a trie data structure in accordance with a sequence of keyboard events, according to some embodiments. When the first node of the trie data structure corresponds to a sequence of characters including the first character and a second character that follows the first character (e.g., the trie node represents two or more sort keys), for a respective subsequent keyboard event in the sequence of keyboard events, the one or more processors of the device determine (1102) a next character corresponding to the subsequent keyboard event and remain (1104) at the first node when the next character is the second character. For example, if the first trie node represents the sort keys “st”, and the first character in the sequence of keyboard events is “s” and the second character in the sequence of keyboard events is “t”, the one or more processors of the device remains on the first node since the first node represents both the first and second characters. When the next character is not the second character, the typed sequence of characters do not match any entries in the language data (e.g., the language data 322). In other words, the next character forms an invalid sequence of characters in a respective language. In some embodiments, the one or more processors of the device may continue to process the keyboard events without traversing the trie data structure. In other words, the one or more processors of the device no longer attempts to automatically correct or suggest words based on the sequence of keyboard events. In some embodiments, the one or more processors of the device generates a warning in the user interface that indicates that the sequence of keyboard events produced is invalid.

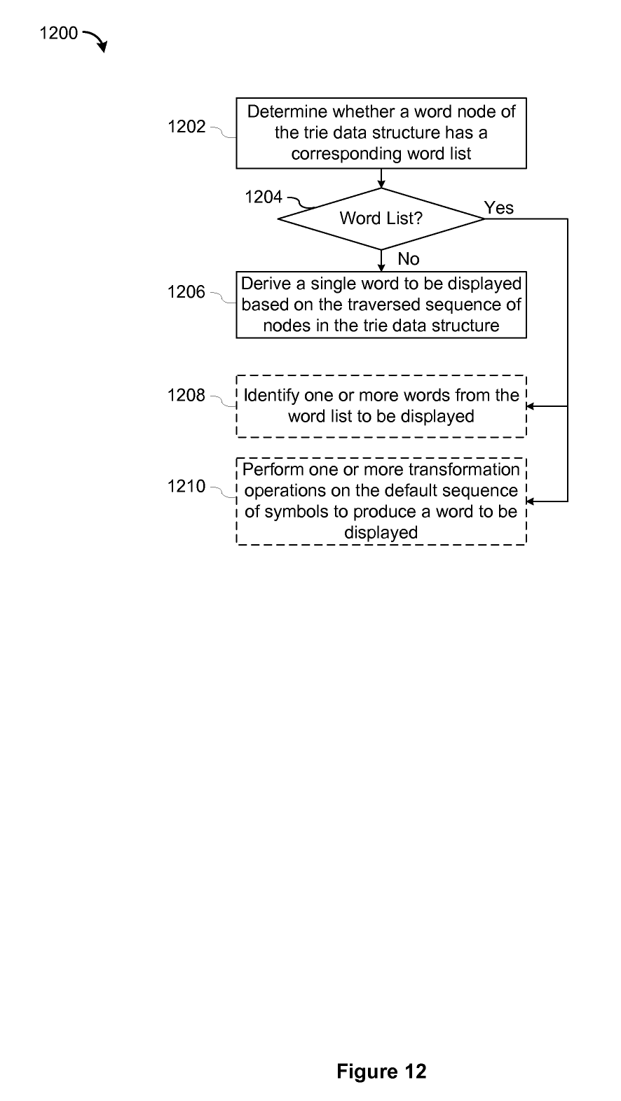

FIG. 12 is a flowchart of a method 1200 for identifying words to be displayed in the user interface of a device, according to some embodiments. The one or more processors of the device determine (1202) whether a word node in the trie data structure has a corresponding word list. In some embodiments, in response to determining that the word node of the trie data structure has a corresponding word list (1204, yes), the one or more processors of the device identify (1208) one or more words from the word list (e.g., word entries 506 in FIG. 5) to be displayed.

In some embodiments, in response to determining that the node of the trie data structure has a corresponding word list (1204, yes), the one or more processors of the device perform (1210) one or more transformation operations (e.g., the transformations 520 in FIG. 5) on the default sequence of symbols to produce a word to be displayed. The transformation operation may include a transformation operation to substitute specified characters of the default sequence of symbols, a transformation operation to insert one or more characters at a specified position in the default sequence of symbols, a transformation operation to insert one or more symbols at a specified position in the default sequence of symbols, and a transformation operation to transform one or more characters of the default sequence of symbols.

In some embodiments, the corresponding word list includes one or more entries, and when the corresponding word list includes two or more entries, each entry corresponds to a respective word and includes a frequency value indicating frequency of occurrence of the respective word.

In response to determining that a word node of the trie data structure does not have a corresponding word list (1204, no), the one or more processors of the device derive (1206) a single word to be displayed based on the traversed sequence of nodes in the trie data structure. For example, the word node may include a word-termination probability (e.g., the word-termination probability 416 in FIG. 4) that indicates that the default form of the word (e.g., the sequence of characters corresponding to the traversed sequence of nodes ending at the word node) is the word that a user is typing. It is noted that when the current node (i.e., the last node of the traversed sequence of nodes) is not a word node, one or more words to be displayed may be determined based on one or more word nodes of the trie data structure that are downstream from the current node. The latter technique is useful for suggesting possible (or popular) word completions to the user.

The methods 800-1200 may be governed by instructions that are stored in a computer readable storage medium and that are executed by one or more processors of a device (e.g., the CPUs 302 of the device 300 in FIG. 3). Each of the operations shown in FIGS. 8-12 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

In some embodiments, the trie data structure described above may be replaced with another tree data structure having nodes that include word nodes having the same or similar properties to those described above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
on a client system having one or more processors executing one or more programs stored on memory of the client system:
receiving a sequence of keyboard events representing keystrokes;
processing the sequence of keyboard events by:
accessing and traversing nodes of a trie data structure in accordance with the sequence of keyboard events, the trie data structure including:
intermediate nodes and word nodes, each word node of the trie data structure corresponding to one or more complete words and having a default sequence of symbols corresponding to a traversed sequence of nodes ending at the word node;
a first respective word node including a reference to a word record specifying two or more distinct words based at least in part on the sequence of keyboard events; and
a second respective word node including no reference to a word record, wherein a complete word corresponding to the second respective word node is determined based on the default sequence of symbols corresponding to the traversed sequence of nodes ending at the second respective word node;
upon arriving at a word node of the trie data structure, identifying one or more corresponding words to be displayed; and
displaying at least one word corresponding to the one or more corresponding words to be displayed.

2. The computer-implemented method of claim 1, wherein accessing and traversing nodes of the trie data structure in accordance with the sequence of keyboard events includes:
receiving a first keyboard event representing a first keystroke in the sequence of keyboard events;
determining a first character corresponding to the first keyboard event; and
locating a first node of the trie data structure that corresponds to the first character.

3. The computer-implemented method of claim 2, further comprising:
when the first node of the trie data structure corresponds only to the first character, for a respective subsequent keyboard event in the sequence of keyboard events,
determining a next character corresponding to the subsequent keyboard event; and
traversing to a next node of the trie data structure from a current node of the trie data structure, wherein the next node of the trie data structure corresponds to the next character.

4. The computer-implemented method of claim 2, further comprising:
when the first node of the trie data structure corresponds to a sequence of characters including the first character and a second character that follows the first character, for a respective subsequent keyboard event in the sequence of keyboard events,
determining a next character corresponding to the subsequent keyboard event; and
remaining at the first node when the next character is the second character.

5. The computer-implemented method of claim 1, wherein identifying one or more corresponding words to be displayed includes:
determining whether the node of the trie data structure has a corresponding word list; and
in response to determining that the node of the trie data structure has a corresponding word list, identifying one or more words from the word list to be displayed.

6. The computer-implemented method of claim 5, wherein the corresponding word list includes metadata for the one or more words.

7. The computer-implemented method of claim 6, wherein the metadata includes a frequency of occurrence of a respective word in a respective language.

8. The computer-implemented method of claim 5, wherein in response to determining that the node of the trie data structure is a word node that does not have a corresponding word list, deriving a single word to be displayed based on the traversed sequence of nodes in the trie data structure.

9. The computer-implemented method of claim 5, wherein the corresponding word list includes one or more entries, and when the corresponding word list includes two or more entries, each entry corresponds to a respective word and includes a frequency value indicating frequency of occurrence of the respective word.

10. The computer-implemented method of claim 1, wherein identifying one or more corresponding words to be displayed includes:
determining whether the node of the trie data structure has a corresponding word list; and
in response to determining that the node of the trie data structure has a corresponding word list, performing one or more transformation operations on the default sequence of symbols to produce a word to be displayed.

11. The computer-implemented method of claim 10, wherein a respective entry of the corresponding word list includes a substitution list, the substitution list including one or more transformation operations, including a transformation operation selected from the group consisting of:
a transformation operation to substitute specified characters of the default sequence of symbols;
a transformation operation to insert one or more characters at a specified position in the default sequence of symbols;
a transformation operation to insert one or more symbols at a specified position in the default sequence of symbols; and
a transformation operation to transform one or more characters of the default sequence of symbols.

12. The computer-implemented method of claim 1, wherein a respective node of the trie data structure corresponds to one or more character forms.

13. The computer-implemented method of claim 12, wherein the one or more character forms include at least one of:
a capitalized character form;
an uncapitalized character form;
an accented character form; and
an unaccented character form.

14. The computer-implemented method of claim 1, wherein displaying at least one word corresponding to the one or more corresponding words to be displayed includes displaying only a single word based on a frequency of occurrence of the one word in a respective language.

15. A client system, comprising:
one or more processors;
memory; and
one or more programs stored in the memory, the one or more programs comprising instructions to:
receive a sequence of keyboard events representing keystrokes;
process the sequence of keyboard events by:
accessing and traversing nodes of a trie data structure in accordance with the sequence of keyboard events, the trie data structure including:
intermediate nodes and word nodes, each word node of the trie data structure corresponding to one or more complete words and having a default sequence of symbols corresponding to a traversed sequence of nodes ending at the word node;
a first respective word node including a reference to a word record specifying two or more distinct words based at least in part on the sequence of keyboard events; and
a second respective word node including no reference to a word record, wherein a complete word corresponding to the second respective word node is determined based on the default sequence of symbols corresponding to the traversed sequence of nodes ending at the second respective word node;
upon arriving at a word node of the trie data structure, identifying one or more corresponding words to be displayed; and
displaying at least one word corresponding to the one or more corresponding words to be displayed.

16. The client system of claim 15, wherein the instructions to access and traverse nodes of the trie data structure in accordance with the sequence of keyboard events includes instructions to:
receive a first keyboard event representing a first keystroke in the sequence of keyboard events;
determine a first character corresponding to the first keyboard event; and
locate a first node of the trie data structure that corresponds to the first character.

17. The client system of claim 16, further comprising instructions to:
when the first node of the trie data structure corresponds only to the first character, for a respective subsequent keyboard event in the sequence of keyboard events,
determine a next character corresponding to the subsequent keyboard event; and
traverse to a next node of the trie data structure from a current node of the trie data structure, wherein the next node of the trie data structure corresponds to the next character.

18. The client system of claim 16, further comprising instructions to:
when the first node of the trie data structure corresponds to a sequence of characters including the first character and a second character that follows the first character, for a respective subsequent keyboard event in the sequence of keyboard events,
determine a next character corresponding to the subsequent keyboard event; and
remain at the first node when the next character is the second character.

19. The client system of claim 15, wherein the instructions to identify one or more corresponding words to be displayed include instructions to:
determine whether the word node of the trie data structure has a corresponding word list; and
identify one or more words from the word list to be displayed in response to determining that the node of the trie data structure has a corresponding word list.

20. The client system of claim 19, wherein the corresponding word list includes metadata for the one or more words.

21. The client system of claim 20, wherein the metadata includes a frequency of occurrence of a respective word in a respective language.

22. The client system of claim 19, further comprising instructions to derive a single word to be displayed based on the traversed sequence of nodes in the trie data structure when the node of the trie data structure is a word node that does not have a corresponding word list.

23. The client system of claim 19, wherein the corresponding word list includes one or more entries, and when the corresponding word list includes two or more entries, each entry corresponds to a respective word and includes a frequency value indicating frequency of occurrence of the respective word.

24. The client system of claim 15, wherein the instructions to identify one or more corresponding words to be displayed include instructions to:
determine whether the node of the trie data structure has a corresponding word list; and
perform one or more transformation operations on the default sequence of symbols to produce a word to be displayed in response to determining that the node of the trie data structure has a corresponding word list.

25. The client system of claim 24, wherein a respective entry of the corresponding word list includes a substitution list, the substitution list including one or more transformation operations, including a transformation operation selected from the group consisting of:
a transformation operation to substitute specified characters of the default sequence of symbols;
a transformation operation to insert one or more characters at a specified position in the default sequence of symbols;
a transformation operation to insert one or more symbols at a specified position in the default sequence of symbols; and
a transformation operation to transform one or more characters of the default sequence of symbols.

26. The client system of claim 15, wherein a respective node of the trie data structure corresponds to one or more character forms.

27. The client system of claim 26, wherein the one or more character forms include at least one of:
a capitalized character form;
an uncapitalized character form;
an accented character form; and
an unaccented character form.

28. The client system of claim 15, wherein the instructions to display at least one word corresponding to the one or more corresponding words to be displayed include instructions to display only a single word based on a frequency of occurrence of the one word in a respective language.

29. A computer readable storage medium storing one or more programs configured for execution by a computer, the one or more programs comprising instructions to:
receive a sequence of keyboard events representing keystrokes;
process the sequence of keyboard events by:
accessing and traversing nodes of a trie data structure in accordance with the sequence of keyboard events, the trie data structure including:
intermediate nodes and word nodes, each word node of the trie data structure corresponding to one or more complete words and having a default sequence of symbols corresponding to s traversed sequence of nodes ending at the word node;
a first respective word node including a reference to a word record specifying two or more distinct words based at least in part on the sequence of keyboard events; and
a second respective word node including no reference to a word record, wherein a complete word corresponding to the second respective word node is determined based on the default sequence of symbols corresponding to the traversed sequence of nodes ending at the second respective word node;
upon arriving at a word node of the trie data structure, identifying one or more corresponding words to be displayed; and
displaying at least one word corresponding to the one or more corresponding words to be displayed.

30. The computer readable storage medium of claim 29, wherein the instructions to access and traverse nodes of the trie data structure in accordance with the sequence of keyboard events includes instructions to:
receive a first keyboard event representing a first keystroke in the sequence of keyboard events;
determine a first character corresponding to the first keyboard event; and
locate a first node of the trie data structure that corresponds to the first character.

31. The computer readable storage medium of claim 30, further comprising instructions to:
when the first node of the trie data structure corresponds only to the first character, for a respective subsequent keyboard event in the sequence of keyboard events,
determine a next character corresponding to the subsequent keyboard event; and
traverse to a next node of the trie data structure from a current node of the trie data structure, wherein the next node of the trie data structure corresponds to the next character.

32. The computer readable storage medium of claim 30, further comprising instructions to:
when the first node of the trie data structure corresponds to a sequence of characters including the first character and a second character that follows the first character, for a respective subsequent keyboard event in the sequence of keyboard events,
determine a next character corresponding to the subsequent keyboard event; and
remain at the first node when the next character is the second character.

33. The computer readable storage medium of claim 29, wherein the instructions to identify one or more corresponding words to be displayed include instructions to:
determine whether the node of the trie data structure has a corresponding word list; and
identify one or more words from the word list to be displayed in response to determining that the node of the trie data structure has a corresponding word list.

34. The computer readable storage medium of claim 33, wherein the corresponding word list includes metadata for the one or more words.

35. The computer readable storage medium of claim 34, wherein the metadata includes a frequency of occurrence of a respective word in a respective language.

36. The computer readable storage medium of claim 33, further comprising instructions to derive a single word to be displayed based on the traversed sequence of nodes in the trie data structure when the node of the trie data structure does not have a corresponding word list.

37. The computer readable storage medium of claim 33, wherein the corresponding word list includes one or more entries, and when the corresponding word list includes two or more entries, each entry corresponds to a respective word and includes a frequency value indicating frequency of occurrence of the respective word.

38. The computer readable storage medium of claim 29, wherein the instructions to identify one or more corresponding words to be displayed include instructions to:
determine whether the node of the trie data structure has a corresponding word list; and
perform one or more transformation operations on the default sequence of symbols to produce a word to be displayed in response to determining that the node of the trie data structure has a corresponding word list.

39. The computer readable storage medium of claim 38, wherein a respective entry of the corresponding word list includes a substitution list, the substitution list including one or more transformation operations, including a transformation operation selected from the group consisting of:
a transformation operation to substitute specified characters of the default sequence of symbols;
a transformation operation to insert one or more characters at a specified position in the default sequence of symbols;
a transformation operation to insert one or more symbols at a specified position in the default sequence of symbols; and
a transformation operation to transform one or more characters of the default sequence of symbols.

40. The computer readable storage medium of claim 29, wherein a respective node of the trie data structure corresponds to one or more character forms.

41. The computer readable storage medium of claim 40, wherein the one or more character forms include at least one of:
a capitalized character form;
an uncapitalized character form;
an accented character form; and
an unaccented character form.

42. The computer readable storage medium of claim 29, wherein the instructions to display at least one word corresponding to the one or more corresponding words to be displayed include instructions to display only a single word based on a frequency of occurrence of the one word in a respective language.
